(19) United States
(12) Patent Application Publication
(10) Pub. No.: US 2007/0093143 A1
(43) Pub. Date: Apr. 26, 2007

(54) Structure of connecting press-fit terminal to board

(75) Inventor: Yoshiyuki Nomura, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 11/580,960

(22) Filed: Oct. 16, 2006

(30) Foreign Application Priority Data
Oct. 26, 2005 (JP) 2005-311056

(51) Int. Cl. H01R 13/42

(52) U.S. Cl. 439/751

(57) ABSTRACT

In a connecting structure in which a press-fit terminal 1 is inserted in a press-fitted condition in a through hole 3 in a board 2, a terminal plating layer 4 is formed at least on a board insertion portion of the press-fit terminal 1, and a through hole plating layer 5 is formed at least on a press-fit terminal contacting portion of the through hole 3. A combination of metals having high mutual solubility are selected respectively as a metal forming the terminal plating layer 4 and a metal forming the through hole plating layer 5.

### BACKGROUND OF THE INVENTION

This invention relates to a structure of connecting a press-fit terminal to a board such as a printed wiring board, in which the press-fit terminal is press-fitted in a through hole in the board in such a manner that a higher retaining force can be secured.

As a method of fixing a terminal to a board such as a printed wiring board, there is conventionally known a press-fit connection in which a press-fit terminal is inserted into a through hole formed in a board, and is mechanically fixed thereto without using soldering.

In the press-fit connection, the press-fit terminal, having a width slightly larger than a diameter of the through hole in the board, is press-fitted into the through hole, thereby producing a mechanical contact load between the terminal and the through hole, thus obtaining good electrical connection therebetween.

In order to produce a suitable contact load between the contacting portions of the press-fit terminal and the through hole, generally, the press-fit terminal is formed into a terminal shape having spring properties, that is, a so-called “compliant shape”. Here, “the suitable contact load” means a load which can secure a low contact resistance over a long period of time, and also will not impart damage such as interlaminer delamination, ply separation, etc., to the board.

Generally, such a board comprises laminated sheets each formed by combining glass fibers in every direction and then by impregnating the combined glass fibers with an epoxy resin, and wiring circuit patterns and through holes made of an electrically conductive material are provided at the board. Plating is applied to each through hole, and the through holes are electrically connected to the wiring circuit patterns.

In the press-fit connection, when inserting the press-fit terminal into the through hole, the inserting force need to be kept to such a level as not to damage the board and the plating on the through hole. After the insertion, it is necessary to secure a sufficient retaining force (terminal withdrawal prevention force) to prevent the press-fit terminal from withdrawal from the through hole due to a heat cycle and mechanical vibration.

Heretofore, there have been proposed a method in which a composite plating layer having rigid grains is formed on a surface of a press-fit terminal, and a physical anchoring effect is developed between a through hole in a board and the terminal, thereby increasing a retaining force after the insertion of the press-fit terminal (see Patent Literature 1), a method in which gold plating is applied to one of a press-fit terminal and a through hole to roughen a surface thereof, a method in which a press-fit terminal is press-fitted with gold grains disposed at the interface between the press-fit terminal and a board, and a method in which after a press-fit terminal is press-fitted into a through hole, solder particles at the interface therebetween are heated and melted (see Patent Literature 2).
[Patent Literature 1] JP-A-2004-227800
[Patent Literature 2] JP-A-8-153943

However, in the conventional techniques disclosed in the above Patent Literatures, there have been encountered problems that the plating process becomes complicated and that the heating and melting step, etc., must be added after the press-fit connection.

### SUMMARY OF THE INVENTION

It is an object of this invention to provide a structure of connecting a press-fit terminal to a board in which a process of applying plating to the press-fit terminal, as well as a process of applying plating to a through hole in the board, is not complicated, and after the press-fit connection, any subsequent step such as a heating and melting step does not need to be added, and the connection is stable, and at the same time a good retaining force is obtained without lowering an insulating performance of the board for a long period of time.

The above object has been achieved by a structure of the present invention for connecting a press-fit terminal to a board wherein the press-fit terminal is inserted in a press-fitted condition in a through hole in the board; characterized in that a terminal plating layer is formed at least on a board insertion portion of the press-fit terminal; and a through hole plating layer is formed at least on a press-fit terminal contacting portion of the through hole; and a combination of metals having high mutual solubility are selected respectively as a metal forming the terminal plating layer and a metal forming the through hole plating layer.

In the above press-fit terminal-board connection structure of the invention, preferably, the terminal plating layer is formed by Sn reflow plating.

In the above press-fit terminal-board connection structure of the invention, contact oil is coated on the press-fit terminal before the press-fit terminal is inserted into the through hole.

In the press-fit terminal-board connection structure of the invention, the process of applying plating to the press-fit terminal, as well as the process of applying plating to the through hole in the board, is not complicated, and besides after the press-fit connection, any subsequent step such as a heating and melting step does not need to be added, and the connection is stable, and at the same time the good retaining force is obtained without lowering an insulating performance of the board for a long period of time.

### BRIEF DESCRIPTION OF THE DRAWINGS

FIGS. 1A and 1B are views showing a press-fit terminal-board connection structure of the present invention, and FIG. 1A is a view explanatory of a condition before the connection, and FIG. 1B is a view explanatory of a condition after the connection.

FIG. 2 is a table showing mutual solubility of metals.

FIG. 3 is a view showing a method of measuring a retaining force.

FIG. 4 is graph showing measured values of retaining forces in the case of connector insertion.

FIG. 5 is a graph showing measured values of retaining forces in the case of individual pin insertion.

### DETAILED DESCRIPTION OF THE PREFERRED EMBODIMENTS

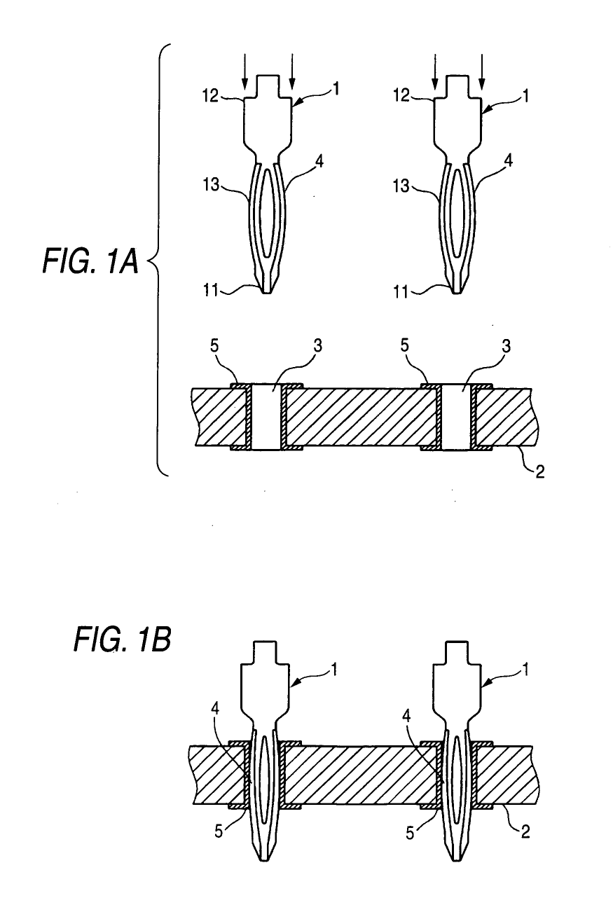

A preferred embodiment of the present invention will now be described in detail with reference to the drawings. As shown in FIGS. 1A and 1B, a press-fit terminal-board connection structure of the invention is such that press-fit terminals 1 are inserted in a press-fitted condition in respective electrically-conductive through holes 3 in a board 2.

As shown in FIG. 1A, the press-fit terminal 1 has a front end portion formed into a tapering shape to provide a guide portion 11, and a rear end portion thereof is formed as a mounting portion 12 to which a mating terminal (not shown) can be attached. That portion of the press-fit terminal 1 disposed between the guide portion 11 and the mounting portion 12 serves as a connecting portion 13 which can contact the inner surface of the through hole 3 to be electrically connected thereto. Plating is applied to a surface of the press-fit terminal 1 to form a terminal plating layer 4. The terminal plating layer 4 need to be formed at least on a board insertion portion of the press-fit terminal 1, or may be formed on the whole of the press-fit terminal 1.

Various electrically-conducing paths (not particularly shown in the drawings) are formed on opposite sides or surfaces of the board 2, and the plurality of through holes 3 are formed through the board 2 as shown in FIG. 1A. A through hole plating layer 5 is formed on an inner peripheral surface of each through hole 3 and also at peripheral edge portions of opposite open ends thereof. The through hole plating lay 5 need to be formed at least on a terminal contacting portion of the through hole 3 to be connected to the electrically-conducting paths on the opposite sides (surfaces) of the board 2.

As shown in FIG. 1A, a width (hereinafter often referred to as “terminal width”) of the connecting portion 13 of the press-fit terminal 1 is larger than a diameter of the through hole 3. When the press-fit terminal 1 is inserted into the through hole 3 in the board 2, the connecting portion 13 is deformed in a manner to reduce the terminal width, and is inserted in a press-fitted condition in the through hole 3. The terminal plating layer 4 of the press-fit terminal 1 contacts the through hole plating layer 5 of the board 2, so that the press-fit terminal 1 is electrically connected to the board 2. The press-fit terminal 1 is obtained by applying metallic plating to a terminal substrate formed by pressing a wire of metal with good electrical conductivity such as a copper alloy.

A combination of metals having high mutual solubility are selected respectively as a metal forming the terminal plating layer 4 of the press-fit terminal 1 and a metal forming the through hole plating layer 5 of the board 2. As a result of selecting the combination of metals having high mutual solubility for the metal of the terminal plating layer 4 and the metal of the through hole plating layer 5, metallic adhesion develops at the interface between the through hole 3 and the press-fit terminal 1, so that a high retaining force can be obtained.

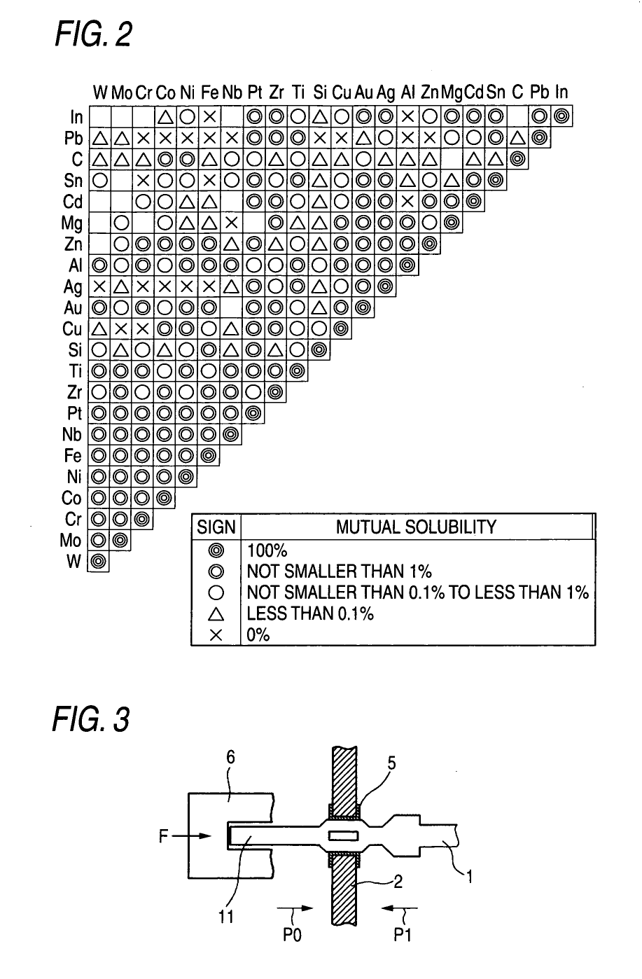

FIG. 2 shows a table indicating the relation between the combination of metals and the mutual solubility. Specifically, “to select a combination of metals having high mutual solubility” means “to select any of combinations of two metals having mutual solubility of not smaller than 0.1% in the table of FIG. 2. Preferably, a combination of metals having mutual solubility of not smaller than 1% (in the table of FIG. 2) is selected, and by doing so, the more excellent retaining force can be obtained.

Referring specifically to a combination of plating layer metals having high mutual solubility, for example, in the case of using the press-fit terminal 1 having Sn plating applied thereto as the terminal plating layer 4, a combination of Sn and Au as well as a combination of Sn and Ag have mutual solubility of not smaller than 1% (in the table of FIG. 2), and a combination of Sn and Sn have mutual solubility of 100% (in the table of FIG. 2). Namely, Au plating, Ag plating or Sn plating should be selected for forming the through hole plating layer 5.

The terminal plating layer 4 and the through hole plating layer 5 can be formed by an ordinary plating method. In this case, there is no need to use a special plating method such for example as a method of forming a composite plating layer having rigid grains at its surface. And besides, after the press-fit terminal 1 is inserted into the through hole 3 in the board 2, it is not necessary to carry out a special step such for example as a step of heating and melting solder, and the press-fit terminal can be connected to the board by a simple method of merely press-fitting the press-fit terminal into the through hole in the board.

When the metallic adhesion force increases, the good retaining force is obtained after the insertion of the terminal; however, the ability of sliding the press-fit terminal 1 during the insertion thereof is lowered, and the inserting force increases, and therefore there is a risk that the board may be damaged. In this case, preferably, contact oil is coated on the surface of the press-fit terminal 1, and then the press-fit terminal 1 is inserted into the through hole 3. The coating of the contact oil can reduce the inserting force produced when inserting the press-fit terminal 1 into the through hole 3.

Preferably, Sn plating is used to form the terminal plating layer 4. Preferably, Au plating, Ag plating or Sn plating is used to form the through hole plating layer 5.

Incidentally, when the press-fit terminal 1, having the terminal plating layer 4 formed by Sn plating, is press-fitted into the through hole 3, the terminal plating layer 4 is, in some cases, shaved or scraped off, thus inviting so-called plating scraping-off. In this case, Sn reflow plating is used to form the terminal plating layer 4, and by doing so, the plating scraping-off can be satisfactorily prevented.

A process of the Sn reflow plating is as follows. First, an undercoat plating layer is formed on a surface of a substrate. Then, an Sn plating layer is formed on the undercoat plating layer. Thereafter, a heat treatment is carried out to reflow the above plating layers, thereby forming a layer of alloy of the undercoat plating metal and Sn. As a result, an Sn layer which is not alloyed is formed in an island-dotted manner at a region in the range of from several nm to 50 nm from the outermost surface of the alloy layer. Preferably, the heat treatment in the reflow process is carried out at temperatures of from about 200° C. to about 300° C.

In the case of the Sn reflow plating, preferably, the thickness of the plating layer before the heat treatment is in the range of from 0.1 μm to 0.7 μm. Within this range, the homogeneous plating layer can be formed on the surface of the connecting portion of the press-fit terminal, and besides the unalloyed Sn can be distributed in an island-dotted manner. The undercoat plating layer may comprise two or more layers.

The press-fit terminal can be formed, for example, by blanking a terminal substrate of a predetermined shape from a wire of metal with good electrical conductivity such as a copper alloy, and then by applying plating to the terminal substrate. Although the terminal substrate thus formed by blanking has a uniform thickness over an entire area thereof, part of the terminal substrate may be changed in thickness by pressing or the like if necessary.

Although the terminal substrate of the press-fit terminal 1 shown in FIG. 1 has a needle eye-shape, the terminal substrate is not particularly limited to this shape, and can have any other suitable shape in so far as the press-fit terminal can be press-fitted into the through hole. An example of shapes of the press-fit terminal which can be press-fitted into the through hole is a solid type in which the cross-sectional shape of the connecting portion will not be deformed upon insertion, and other examples include a C-type, an M-type, an N-type and an H-type in which the cross-sectional shape of the connecting portion is deformed upon insertion.

The press-fit terminal-board connection structure of the invention can be used as structures of connecting various control boards; however, in the case where the connecting structure of the invention is used for connecting wiring boards together in the electric wiring utilized in a severe environment in which high vibration, a high temperature, a high humidity, etc., are encountered as in an automobile, industrial machinery and equipments, etc., it can be used as the optimum connecting structure which can maintain high reliability for a long period of time even in such a severe environment.

Example of the invention and Comparative Example will be described below.

### EXAMPLE 1

There are prepared printed wiring boards in which an undercoat Cu plating layer with a thickness of 25 to 50 μm is formed on each through hole, and a substituted Ag plating layer with a thickness of 0.1 to 0.3 μm is formed on a surface of the undercoat plating layer. An undercoat Ni plating layer and an Sn plating layer are sequentially formed on a surface of each of press-fit terminals, and thereafter a reflow treatment is carried out, so that the resulting press-fit terminal had the undercoat Ni plating layer with a thickness of 1 to 1.3 μm and a thin Sn reflow plating layer with a thickness of 0.3 to 0.5 μm. With this combination, Sn of the terminal plating layer of the press-fit terminal and Ag of the through hole plating layer of the board have mutual solubility of not smaller than 1%.

### COMPARATIVE EXAMPLE 1

Printed wiring boards and press-fit terminals are prepared according to the same procedure as in Example 1 except that an Ni plating layer with a thickness of 1 to 1.3 μm is formed on a surface of each press-fit terminal. Ni of the terminal plating layer of the press-fit terminal and Ag of the through hole plating layer of the board had mutual solubility of less than 0.1%.

The press-fit terminals of Example 1, as well as the press-fit terminals of Comparative Example 1, are assembled in a form of 65-pin connector, and the press-fit terminals are press-fitted into the printed circuit board at a speed of 2 mm/sec., thereby effecting the connector insertion. As another test, the press-fit terminals of Example 1, as well as the press-fit terminals of Comparative Example 1, are individually press-fitted into the printed circuit board at a speed of 50 mm/min., thus effecting the individual pin insertion. The press-fitting of the press-fit terminals are carried out with respect to five kinds of printed wiring boards having through hole diameters of φ0.95, φ1.0, φ1.1, φ1.2 and φ1.25, respectively.

Retaining forces are evaluated after the press-fit terminals of Example 1 and Comparative Example 1 are actually press-fitted into the through holes of the printed wiring boards. This test is effected for the connector-inserted printed circuit boards and the individual pins-inserted printed circuit boards. More specifically, as shown in FIG. 3, a guide portion 11 at a front end of the press-fit terminal 1 is pushed in a direction of arrow PO by an extruding apparatus 6, and a maximum load obtained at this time is defined as the retaining force for the press-fit terminal. The extruding speed at this time is 10 mm/min.

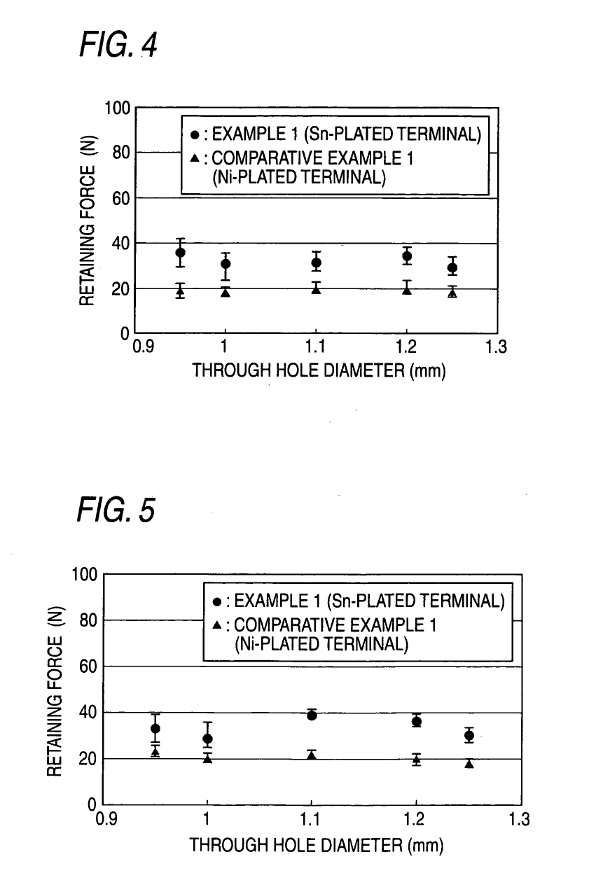

FIG. 4 shows a graph showing measured values of the retaining forces in the case of the connector insertion. FIG. 5 is a graph showing measured values of the retaining forces in the case of the individual pin insertion. In the graphs of FIGS. 4 and 5, each dot (small round mark) indicates an average value of the retaining force, and horizontal lines indicate a maximum value and a minimum value, respectively, and a variation in the measured value is indicated by a vertical line.

In the graphs of FIGS. 4 and 5, a horizontal axis indicates the through hole diameter, and a vertical axis indicates the retaining force. As shown in FIGS. 4 and 5, in either insertion form, the higher retaining forces are obtained in Example 1 using the Sn-plated terminals than Comparative Example 1 using the Ni-plated terminals. This indicates that when a combination of metals having high mutual solubility are selected respectively for the metal of the terminal plating layer 4 and the metal of the through hole plating layer 5, the good retaining force is obtained.

What is claimed is:

1. A structure of connecting a press-fit terminal to a board in which the press-fit terminal is inserted in a press-fitted condition in a through hole in the board, comprising:
a terminal plating layer formed at least on a board insertion portion of the press-fit terminal; and
a through hole plating layer formed at least on a press-fit terminal contacting portion of the through hole, wherein
a combination of metals having high mutual solubility are selected respectively as a metal forming the terminal plating layer and a metal forming the through hole plating layer.

2. The structure of connecting a press-fit terminal to a board according to claim 1, wherein
the terminal plating layer is formed by Sn reflow plating.

3. The structure of connecting a press-fit terminal to a board according to claim 1, wherein
contact oil is coated on the press-fit terminal before the press-fit terminal is inserted into the through hole.

4. The structure of connecting a press-fit terminal to a board according to claim 1, wherein
the terminal plating layer is formed by Sn plating.

5. The structure of connecting a press-fit terminal to a board according to claim 1, wherein
the through hole plating layer is formed by Au plating, Ag plating or Sn plating.

6. The structure of connecting a press-fit terminal to a board according to claim 2, wherein
the heat treatment in the reflow process is carried out at temperatures of from about 200° C. to about 300° C.

7. The structure of connecting a press-fit terminal to a board according to claim 2, wherein
in the case of the Sn reflow plating, the thickness of the plating layer before the heat treatment is in the range of from 0.1 μm to 0.7 μm.
